(19) United States
(12) Patent Application Publication
(10) Pub. No.: US 2009/0030689 A1
(43) Pub. Date: Jan. 29, 2009

(54) Mobile voice recognition data collection and processing

(75) Inventors: Vincent Perrin, Myrtle Beach, SC (US); Judi Perrin, Myrtle Beach, SC (US); Michael Joost, Charleston, SC (US); Kevin Wood, Charleston, SC (US)

Correspondence Address: Attn: Vincent Perrin;AccuTrak Inventory Specialists, LLC, PO Box 14782, Surfside Beach, SC, 29587, US

(73) Assignee: AccuTrak Inventory Specialists, LLC

(21) Appl. No.: 11/542,028

(22) Filed: Oct. 3, 2006

(51) Int. Cl. G10L 15/00

(52) U.S. Cl. 704/246; 704/E15.001

(57) ABSTRACT

Voice recognition methods, systems and interfaces are used to collect data and produce databases that are then searched and used to produce reports or electronic filings. The databases are developed using a hierarchically designed command structure and a hierarchy of relational databases for the entry and recognition of voice commands. The invention uses an Adaptive Grammar that allows a very high probability for accurate recognition and a rapid recognition response to be achieved. The invention allows for multiple users and multiple mobile computers to maximize voice recognition capabilities.

### FIELD OF INVENTION

The present invention, VoTrak Inventory System®, relates to using a voice recognition system as a method to collect data. The invention is a software system that connects hardware and allows for the collection of data using voice recognition. Single or multiple headsets are used to transmit data to a mobile computing unit. These data are then processed, analyzed, stored and reports are generated at the customer's place of business using VoTrak and a mobile computer unit. The data collected involves products kept as inventory, completing surveys, readings from meters or like items. The data could be financial in nature or involve the identification of individual items. This invention allows the verification of existing or the creation of new databases containing financial information or product identifiers using voice recognition. VoTrak uses a unique voice recognition process to collect and store the data. This process requires auditors to train their voice for greater recognition accuracy and allows for multiple auditors to be involved. The data fields are predefined and the grammar is constrained to allow for faster data recognition and better accuracy. Some data, available on an apriori basis, such as product description and pricing may be embedded to increase speed and accuracy. Embedding descriptions provides product inventory information that was not previously available. The data are collected using headsets worn by auditors. The headsets transmit the data to a mobile computing unit that processes the data and transmits a confirmation to the auditor that the data was received verifying the accuracy of the data transmitted. These data could include numbers, letters or words. The confirmation can consist of a repetition of the data or the transmission of a sound to notify the auditor that the data were received accurately. VoTrak, the invention, has the capability of working with multiple concurrent users wearing headsets sending data to a mobile computing unit. The invention also has the capability of working with a network of multiple computer units to facilitate additional headsets/users to provide coverage over a greater area. The microphones have significant noise-canceling capabilities and the speakers are high quality with remote volume controls. The microphone and speaker combination constitutes a headset. The data are transmitted by the microphones to the computing unit using Spread Spectrum Radio Communication or Bluetooth® technology. The invention currently uses Spread Spectrum Radio Communication or Bluetooth technology but is not limited to using these technologies. The computing unit will receive the data with Spread Spectrum Radio Communication or Bluetooth® Transceivers. At times the data collection will also involve a scanner used to read barcodes. The computing units process and analyze the data using VoTrak Inventory System®, the invention. VoTrak is a working software system.

### BACKGROUND OF THE INVENTION

Businesses require that data are collected and analyzed, on their physical inventories, on product dispersed to customers, on meters that provide information, on customer usage and various other situations. The inventory and data collection industry started out collecting this information using pen and paper. Over a number of year's inventions such as calculators made the work easier. A few firms collected data using tape recorders the tapes were then transcribed and the data summarized into reports. These methods took days or even weeks to complete the inventories. To make full use of the data collected, businesses require the results or reports as promptly as feasible. With the invention of computers and miniaturized circuit boards mobile data collectors were invented. The data collectors involved typing on a keyboard into a hand held unit. The data were later inputted or transmitted to a computing unit. The data collected could be the location of the product, barcode, price, quantity or some combination of this information. This method of data collection allowed the data to be collected faster but sometimes accuracy was sacrificed. There are currently available commercial voice recognition engines that work in two fundamental modes: command/control and dictation. The command and control engines constrain the speech to be composed of a set of predefined utterances that must be spoken in an exact order to be recognized. This method increases the speed and accuracy of recognition. Dictation recognizes any spoken utterance. This method is slow and is typically not as accurate. The invention uses a combination of the command and control and the dictation method it. This is accomplished by breaking the digital into auditory fragments that correspond to data fields. In some fields there are very tight controls over the exact utterance while in other fields the controls may be more relaxed. The invention is a mobile data collection system using voice recognition. Voice recognition requires a tremendous amount of computing power, so a system was developed that takes advantage of recent advances in computing technology. There are other applications of voice recognition systems being used in situations such as warehouses to pull inventory and collect stock level data. These systems are stationary and typically single user. The invention is a system that allows multiple auditors, users, on a mobile computer at one time collecting real time data. There is no other mobile system that allows for multiple auditors on the market. There are systems that do not require the auditors to train their voice profiles. While this allows for immediate use of the voice system the recognition typically does not improve with use and recognition accuracy can be an issue. The invention uses assigned profiles for each user. These profiles are updated/improved dynamically without user intervention and are transferable between mobile computers. By training a voice profile, data can be consistently collected with a high degree of accuracy. Using the VoTrak Inventory System®, the invention, data are collected at the customer's location by using Voice Recognition and a mobile computing unit. The use of Voice Recognition in a mobile platform will revolutionize the way data is collected and processed. The data collected using VoTrak Inventory System® can include the location, product identification, price and quantity. The system can also be used to gather data such as serial numbers, bar codes or other product identifiers as well as readings on meters or other applicable units. Using the invention based on a voice recognition system the data can be verified for accuracy at the time they are collected. The invention echoes the information back to the auditor as it is collected which allows corrections to take place immediately in case of error. This feature increases the accuracy of the data collected. The system also uses predefined data fields that limit the data accepted. The data are then stored and analyzed by the attached computer unit or the data can be sent to a main processor to be stored and analyzed. Before the invention, VoTrak Inventory System®, there was a significant chance for errors while collecting data. We have reduced the chance of errors by limiting the vocabulary the system will accept and by echoing the utterance back to the auditor. The invention developed a method of embedding product descriptions and pricing. This allows more information to be collected accurately during the inventory and with a shorter training time for auditors.

### SUMMARY OF THE INVENTION

The present invention provides the opportunity to collect data using Voice Recognition Software to increase auditor's accuracy and production. This invention will allow for data collection in a mobile environment and will be effective whether one auditor is collecting data or 100 auditors are collecting data in a warehouse or large retail environment. This invention has developed a method to isolate the data collected by each headset (auditor) and to store the data with unique identifiers linking the data to the auditor. This allows for a true audit trail to verify the accuracy of the data collected. The data can be collected in a variety of locations regardless of background noise by using high quality noise canceling microphones and technology that uses voice recognition profiles trained for each auditor. The data are collected using predefined models that allow specific data to be collected in a specific order. In some situations the data fields are embedded. This increases voice recognition and accuracy. Multiple computing units can be networked to allow for a large number of auditors (headsets) to be used or when the data needs to be collected in a large area and would be beyond the range of one computing unit. The computing units can then be networked and the data transmitted to a central computing unit. The headset includes both the microphone and a speaker.

### BRIEF DESCRIPTION OF THE DRAWINGS

FIG. 1 shows a brief description of the equipment used in the Voice Recognition System

FIG. 2 illustrates the Mobile Computing Unit

FIG. 2a describes the voice recognition configuration

FIG. 3 illustrates the usage of dual core technology

FIG. 4 illustrates database structure

FIG. 5 illustrates embedded product description, pricing and voice recognition

FIG. 6 illustrates how multiple auditors using microphones are logged on and off the VoTrak system. This also illustrates how the headset volume and the voice recognition to response speed are adjusted for each auditor.

FIG. 7 illustrates the report setup screen and describes the various reporting functions

FIG. 8 Inventory setup and the various functions available including an example of embedding data fields

FIG. 9 illustrates an example of a category detail report used in a financial inventory and illustrates imbedded product description and pricing used in voice recognition

FIG. 10 is an example of data collected during a scan inventory and the function voice recognition plays

FIG. 11 diagrams multiple auditors with headsets transmitting data to one mobile computing unit

FIG. 12 diagrams multiple mobile computing units networked to a central computer. This allows more auditors to work on the project or for data to be collected in a larger area

FIG. 13 illustrates how data is collected in multiple locations simultaneously and networked to a central computer

FIG. 14 illustrates how data is collected from a vehicle using a mobile computer and an auditor wearing a headset

### DETAILED DESCRIPTION OF THE INVENTION

In presenting the detailed description of the invention, examples are used that are based on actual testing of the system. The examples are provided to illustrate certain elements of the invention. They are not to be construed as limiting the invention in any way. The Invention, VoTrak Inventory Systems®, consists of equipment, speech engine controls, grammar formations, databases, and reporting.

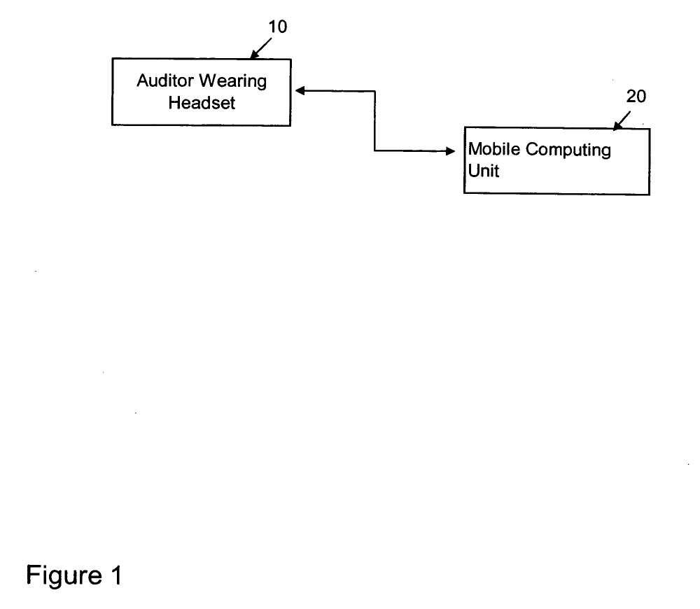

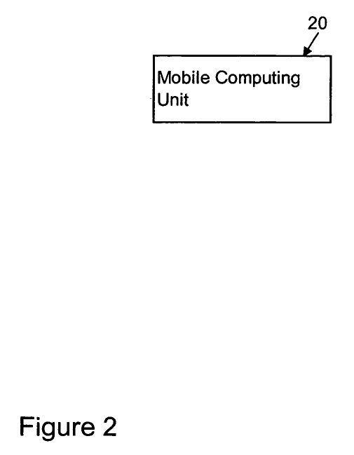

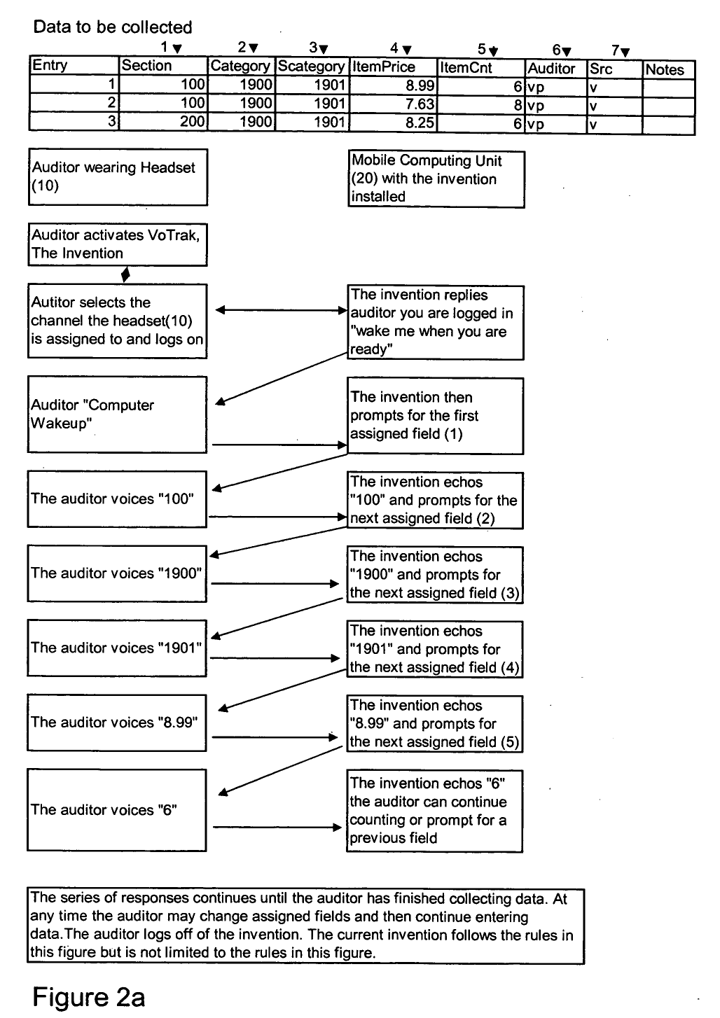

FIGS. 1 and 2 show examples of typical equipment set up. The equipment allows for data to be collected using a headset that consists of a high quality speaker and a noise canceling microphone. The data is digitalized and transmitted by Spread Spectrum Radio Communication or Bluetooth technology to a mobile computer. The invention currently uses Spread Spectrum Radio Communication but is not limited to this technology.

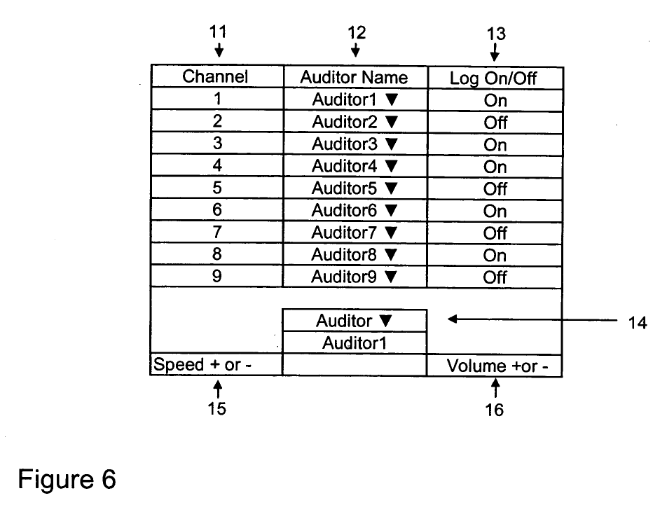

When the invention is activated and a defined inventory structure is chosen the auditors log onto the system (FIG. 6). The VoTrak System allows auditors to log on to the inventory by first selecting the channel (11) their headset is logged on to. They then click on the down arrow (▾) (12) selecting their trained voice profile. Next they click on the log on/off button (13) to either log on or log off. Each auditor can adjust the speed that the voice engine responds to their commands and the volume in their headset by clicking on the Auditor down arrow (▾) (14) selecting their voice profile and using the available speed (15) and volume (16) adjustments. As auditors train their voice profile they can increase the speed that the voice engine responds to them and by doing this increase their production. VoTrak allows auditors to log on and off of the system and change headsets or channels during the audit. The data collected are associated to them by the profile name they select. This is illustrates how the invention currently logs an auditor onto the system but is not intended to limit the methods used to log auditors onto the system.

Once the system is activated the auditor utters a statement “computer wake up” into the microphone. The vendor supplied speech engine communicates the recognition results to the speech runtime function through VoTrak. FIG. 2a illustrates the voice recognition configuration.

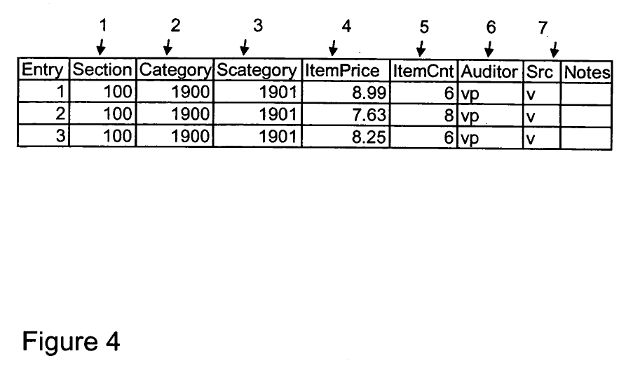

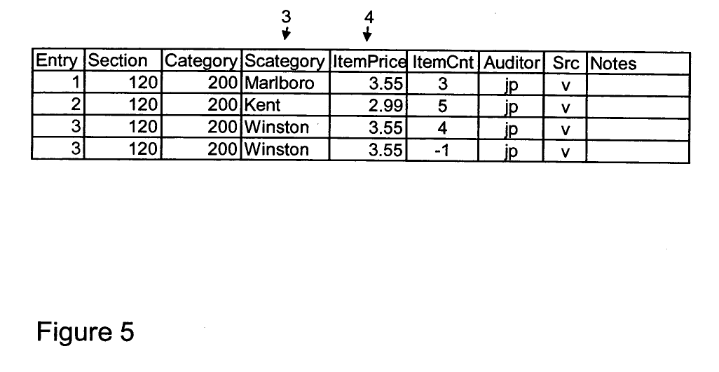

Next the invention takes the information returned by the speech engine, places it within the proper database fields and if appropriate compares predefined data fields before accepting the data. This is illustrated in FIGS. 4 and 5. The invention accepts data in a very structured sequence and the data must match criteria for that field. However, the invention uses Adaptive Grammar that allows us to change the rules for each field. The programmer can change the rules for a field in the invention and make the rule fixed or allow the rule for the particular field to be defined in the field by a supervisor. This feature allows a very high probability for accurate recognition and a rapid recognition response. The system may be comparing the auditor input to the way a series of predefined numbers are entered, to predefined words or to the sequence and length of the numbers entered.
The recognition process takes place using predefined fields shown in FIG. 4. The data are collected in each field in an exact sequence and the data that is allowed to be collected in a field is predefined. In addition to this the auditor has trained a voice profile and tested the profile for recognition capabilities. By predefining the data structure and training the voice profiles we increase the accuracy of speech recognition. This data base example shows data collected during a financial inventory. The data fields are predefined to increase accuracy. Some fields are mandatory and some may be skipped. The rules are defined by the Supervisor. The sequence of the fields allows data to be collected by location (Section) (1), item classification (Category (2) and Scategory (3)), the value of each item (Itemprice) (4) and the number of the items on hand (ItemCnt) (5). The auditor's initials are attached to each count (Auditor) (6) as well as how the data was collected (scr) (7) voice (v) or manual (m). Each entry also has a date and time stamp attached that is used in the audit trail reports or for verifying auditor productivity.

The invention then determines if the data are valid. If the data are not recognized as valid for that field the system will not respond or responds that the data was not valid. If the system feels it is hearing background noise it will not respond. If the data were recognized and determined to be a valid entry the entry is echoed back to the auditor. If the auditor accepts the data they then continue to the next field. If the auditor determines that the system has made an incorrect recognition they then correct the entry.
The correction, FIG. 5, is made by navigating to the quantity field, using voice commands and saying “correction”. The system will then respond that the system is in “correction mode and all entries will be subtracted”. If you had entered an incorrect area, product, price or quantity you would negate it from the database by negating the quantity you had entered in the incorrect entry sequence. All entries are stored to provide a true audit trail.

FIG. 5 demonstrates the use of embedded words, Scategory (3), and embedded prices, ItemPrice (4). The words and prices are pre-defined in the invention. The auditor speaks the word (3) and the software automatically asks for count, while inserting the predefined price (4). This increases the auditors' accuracy and speed. This illustration shows 1 method of using embedded word and prices. The invention is not limited to this example.

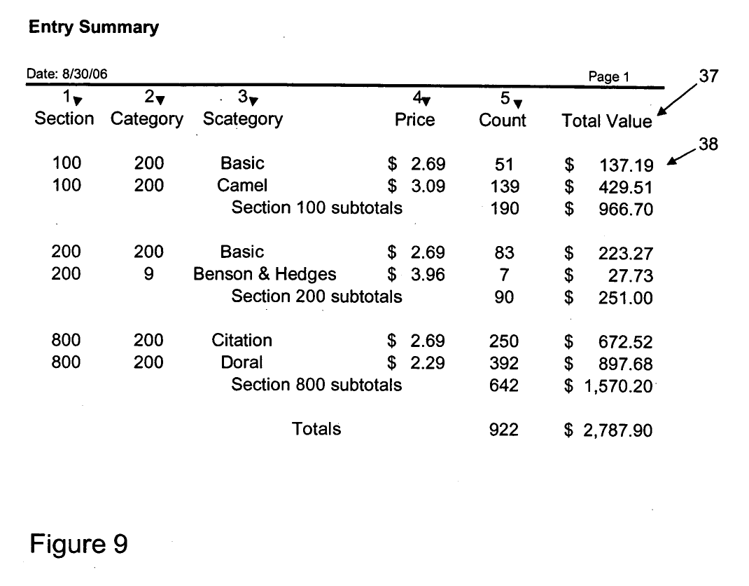

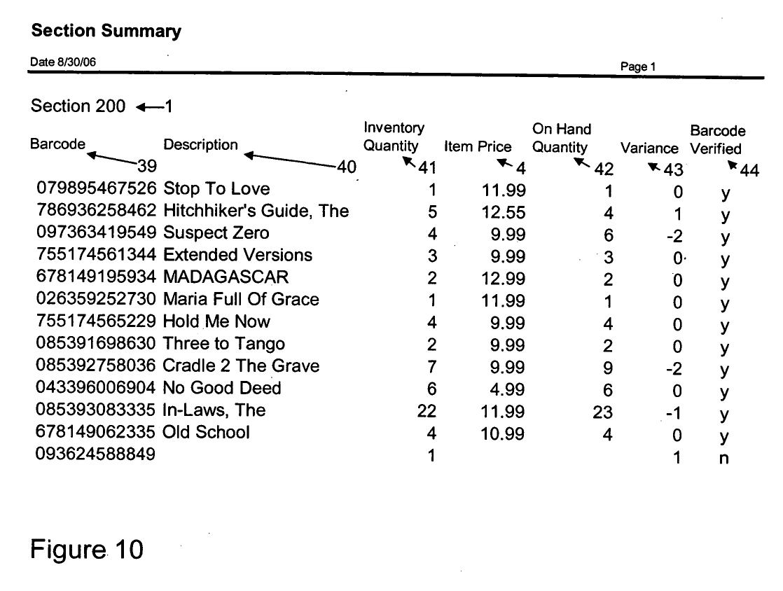

As the data are collected the entries and totals can be viewed to ensure accuracy. Each auditor's entries can be viewed using information available in FIG. 4. The data are assigned to an auditor by the identity chosen at log in FIG. 6. You can see the auditor assigned to the data in FIG. 4, item 6. The totals for data collected can be viewed as reports. Examples of reports are available on FIGS. 9 and 10.

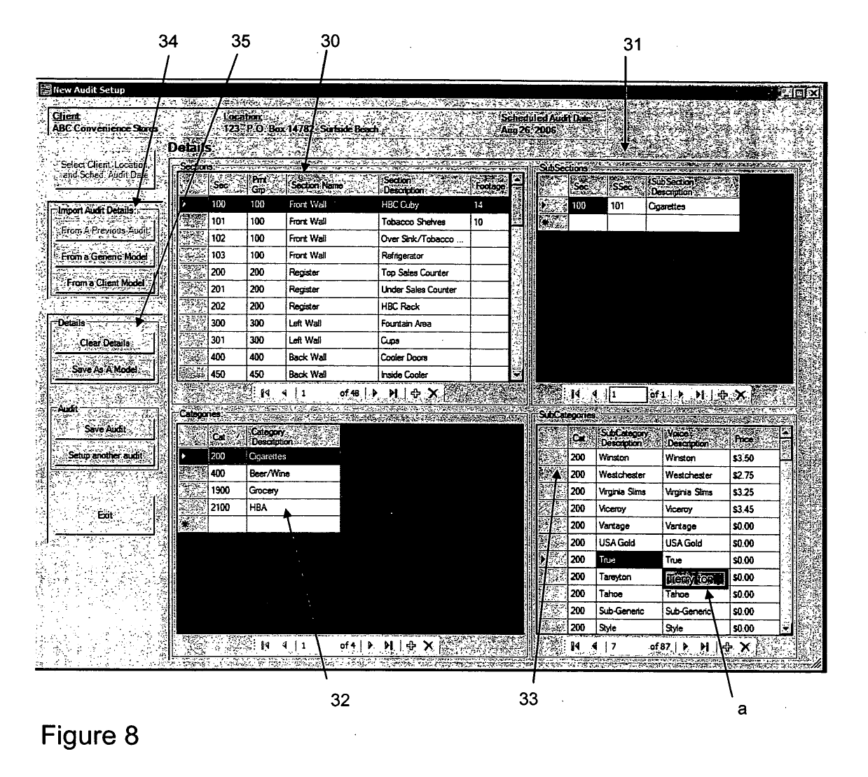

Each project is predefined using VoTrak's Setup function. Options are made and fields of the database are predefined. This is illustrated in FIG. 8. The setup detail allows you to create a permanent template for each customer that is customizable if changes are needed. Using this detail screen we predefine all necessary fields. If the fields are not predefined you can not enter data into them.

### Sections (Physical Area) FIG. 8 (30)

The section (Sec) field will only allow numbers that are predefined. This is the section numeric identifier for voice recognition
The print group (Prnt Grp) tells which section fields should print together on reports
Section Name is to identify the section on reports
Section description tells what is located in the section
Footage tells the auditor how long the section is in feet

### SubSection (Physical Area) FIG. 8 (31)

Sec is the section the subsections is a part of
SubSection (SSec) is the predefined numeric identifier for voice recognition
SubSection Description identifies the subsection by product or location

### Categories (Product Identifier) FIG. 8 (32)

Categories (Cat) this is the predefined numeric identifier for voice recognition
Category Description identifies the category

### Sub Categories (Product Identifier) FIG. 8 (33)

Cat is the category that the subcategory is associated with
Sub Category Description appears on all reports
Voice Description allows for a phonetic spelling of the category description (a). This allows for easier voice recognition. This field is the predefined identifier for voice recognition.
Price is predefined and embedded. When the auditor selects a subcategory the associated price is applied and the auditor is ready to count quantities.

### An Example of Counting a Product: FIG. 2a

VoTrak replies or requests are (VK) Auditor replies or requests are (AR) The database entries are: FIG. 2a

| En- | Sec- | Cate- | | | | Audi- | | |
|---|---|---|---|---|---|---|---|---|
| try | tion | gory | Scategory | ItemPrice | ItemCnt | tor | Src | Notes |
| 1 | 120 | 200 | Marlboro | 3.55 | 3 | jp | v | |

(AR) Computer Wake up (VK) I am ready (AR) Section (VK) Section (AR) 120 (VK) 120 (VK) Category (AR) 200 (VK) 200 (VK) Sub Category (AR) Marlboro (VK) Marlboro (VK) Count (AR) 3 (VK) 3

At this time the auditor would have the option of continuing to count or to change section, category or subcategory. If any fields are changed the invention would follow the same pattern as above.

The invention has commands built in such as:
Correction that allows you to negate the item count filed if there was an error made in any of the previous fields. The data is retained in the database for true audit trails but takes the sequence out of total count totals
Repeat voices back the previous 10 entries
Value tells the value of the current section you are counting and gives you a break down by category.

The invention is not limited to the commands previously described the commands were used as examples for the previous count sequence.

The invention also gives us the capabilities of Importing audit details, FIG. 8 (Area 34), from a previous audit, a generic model or from a client model. If you import audit details the Section, Subsection, Category and Sub Category fields are filled in by the data imported. VoTrak can save the setup that as a model for future use.

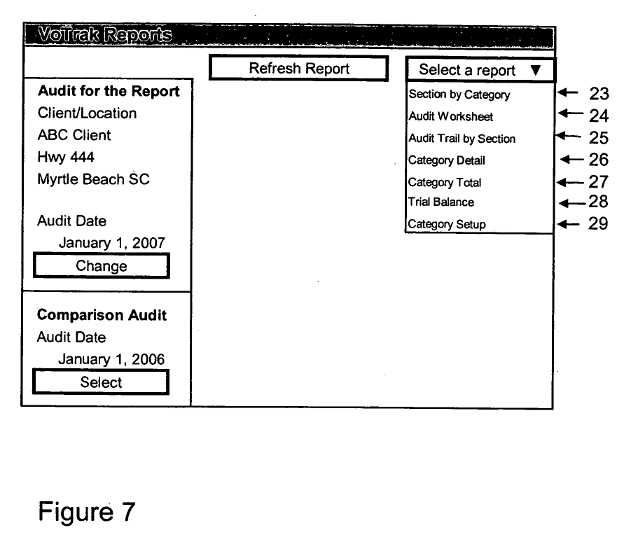

At any time during the audit or when the audit is complete the database totals can be reviewed by opening VoTrak Reports, FIG. 7.

Each mobile computer has the ability to run VoTrak Reports. VoTrak Reports is built into the invention and used to analyze the data that has been collected. This can mean running a multitude of reports to satisfy the customers requirements. Financial Inventories:

Financial inventories can require the following reports. This is just a sample of the reporting function not necessarily all reports available.
Section by Category (23) tells how much of each category is available in each section. This report is usually compared to a previous inventory and is used to test for accuracy.
Auditor work sheet (24) prints out each section with a description to assist during the inventory
Audit Trail by Section (25) shows each voice entry by the time stamp and auditor. This report is usually run by section to check for accuracy of data collected
Category reports (26) (27) tell the dollars and some times the piece count of each category of product. Some sample categories may be groceries, clothing, beer or cigarettes.
Trial Balance (28) allows the auditors to print a section by Category report with no totals or headers to review before printing the final reports
Category Setup (29) reports allow the auditors to print a listing of all categories and subcategories.

This is an example of how VoTrak Reports works for a specific data collection method, financial inventory. This is not the only function of the reporting system.

When the auditors collect data and transmit the data to the invention the data is stored in a database in appropriate fields. VoTrak Reports pulls the data from the database and creates reports that provide our customers with the information they require. The reports can be used to verify counts during the audit and to give various totals at the end of the audit. There are examples of reports on FIGS. 9 and 10.

### FIG. 9 Category Detail Report:

The Category Detail Report provides the customer with details about product by location. The data is collected using voice entry. The Section (1) information indicates a location, the Category (2) indicates a product code, Scategory (3) gives the product detail, Price (4) is the price per item, Count (5) indicates the quantity of the product on hand and Total Value (37) extends the count times the price. The Description and Price are embedded in the invention. To count the line marked (38) the auditor would say Section the computer would respond Section (auditor) 100 (computer) 100; (computer) category (auditor) 200 (computer) 200; (computer) subcategory (auditor) Basic; (computer) count (auditor) 51. The computer stores the data. This is an example of a current method used by the invention.

### FIG. 10 The Scan Report:

This data is provided to the customer for their review using the Section Summary. A section is a specific location within the inventory this report is a summary of the data collected in Section 200 (1). Barcode (39) or UPC is product identifiers generated by the customer or manufacturer. The Barcode is scanned using a handheld device. The Description (40) is used to verify the identity of the product. Inventory Quantity (41) identifies the quantity voice counted by the auditor. Item Price (4) is the price marked on the product, this is voiced in by the auditor. On Hand Quantity (42) represents the customers anticipated quantity. Variance (43) is the difference between Inventoried Quantity and On Hand Quantity. Barcode Verified (44) indicates that the scan matched y/n an existing barcode in the customer's database. Method of using the invention while collecting barcode data; the product is picked up and the Barcode is located and then scanned, the data base is searched and notifies the auditor if the barcode is verified or not. If it is not verified the auditor physically marks the item. The quantity and then the price are voiced in. The data is accumulated and all calculations are performed. The invention repeats all voiced commands to the auditor for verification. The current invention uses this method to collect data but is not limited to this method in the future

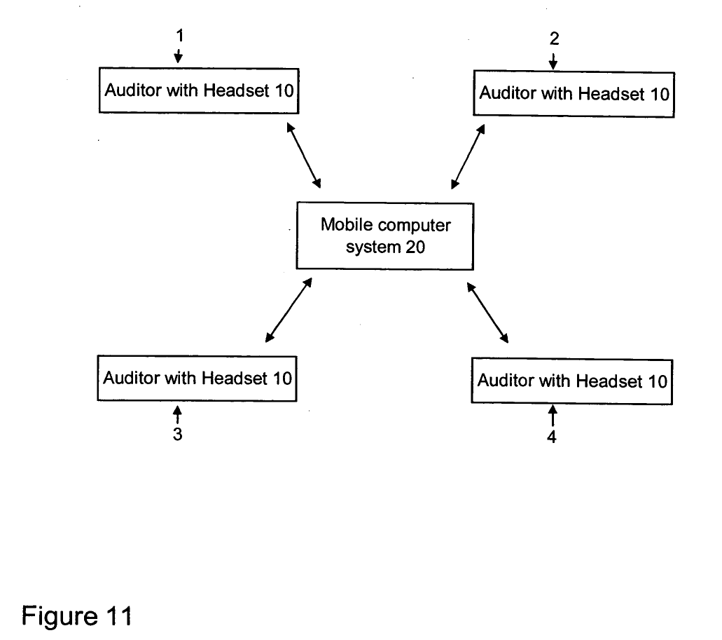

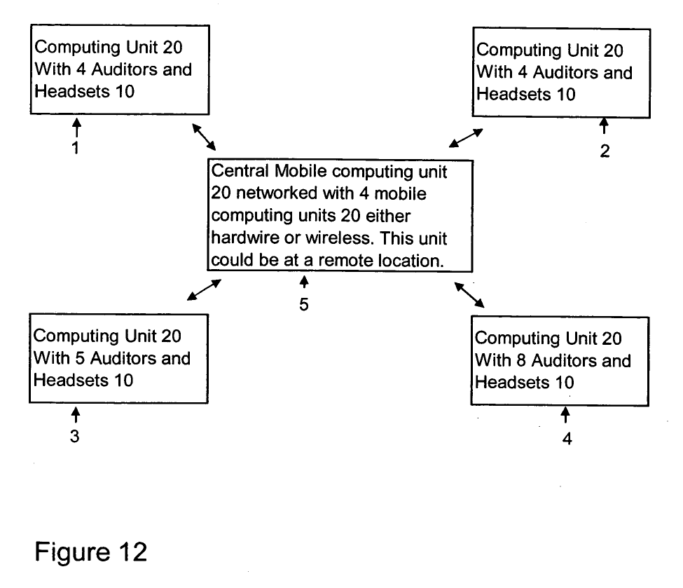

There are currently computer limitations that have to be dealt with when building a mobile voice recognition system. Mobile Computer Systems available today will support a limited number of auditors using headsets transmitting with either Spread Spectrum Radio Communication or blue tooth technologies. This is illustrated in FIG. 11 and depending on the mobile computing system the number of auditors per system is 3 to 8. We are required to undertake projects that require additional auditors so we have the invention network mobile computer systems, FIG. 12. Each mobile computer (20) has the capabilities of supporting 3 to 8 auditors and transmits the data back to the central mobile computer for storing collected data and producing reports. The central mobile computer will usually be on site but may be located elsewhere. The computer systems may be hardwired or connected using a wireless network.

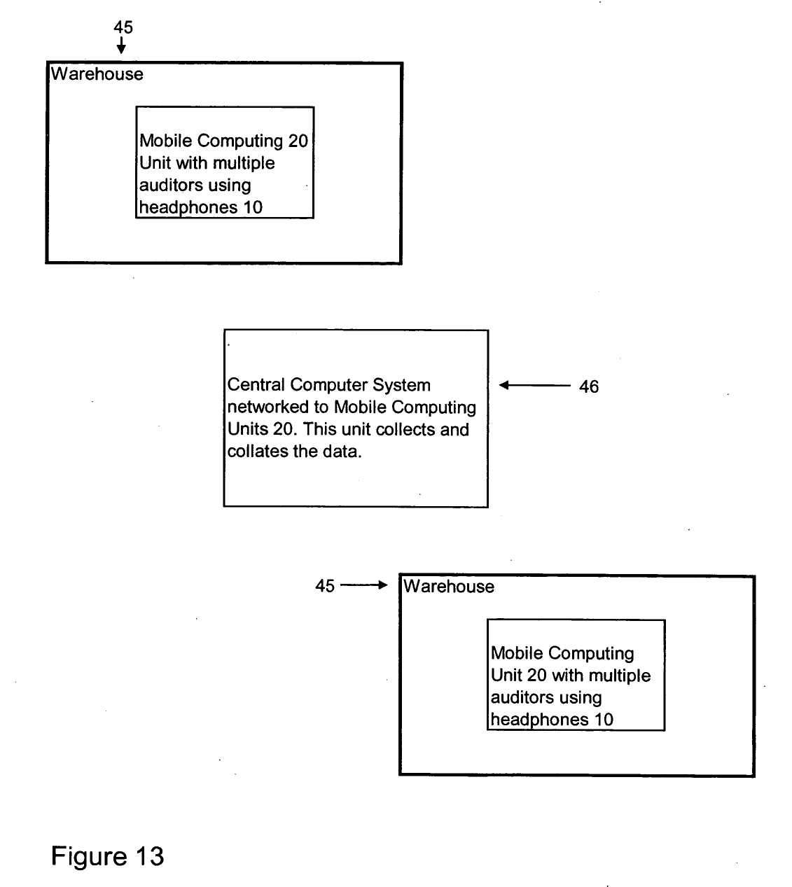

Headsets (10) have a limited range of 100 to 300 feet depending upon conditions. There are times where auditors are required to produce real time results for an area greater than this. The invention uses a system that will network mobile computer systems, FIG. 13. Each mobile computer will send the data back to the central mobile computer for storing collected data and producing reports. The central mobile computer will usually be on site but may be located elsewhere. The computer systems may be hardwired or to connected using a wireless network. This would allow Mobile Computing Units (20) to be located in Warehouses (45) and sending data back to a Central Computer System (46).

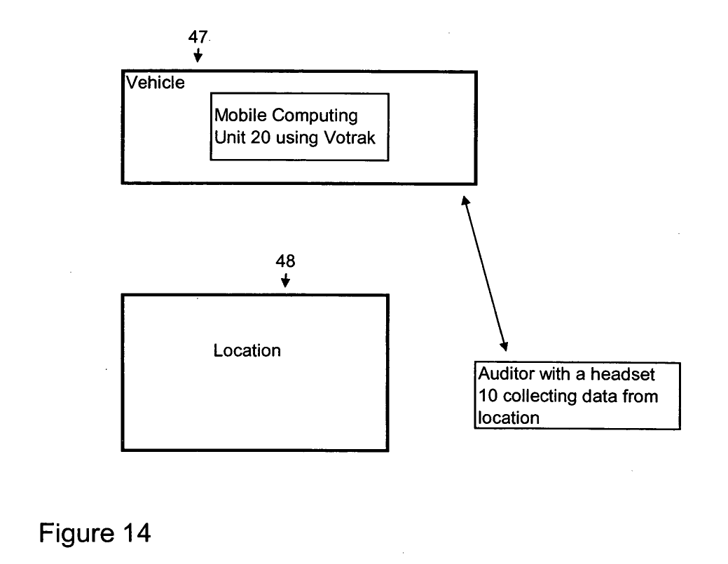

VoTrak is used to collect data from various locations that do not require the mobile computer be set up on site. This could be for survey work, price verification or comparison or reading meters or cycles. VoTrak is not limited to these instances but they are used as examples. In FIG. 14 we illustrate a mobile computer system mounted in a vehicle (47) and an auditor collecting data at a location (48) using a headset (10). Reports could be printed on site or the data could be collected and provided to the client at a later time.

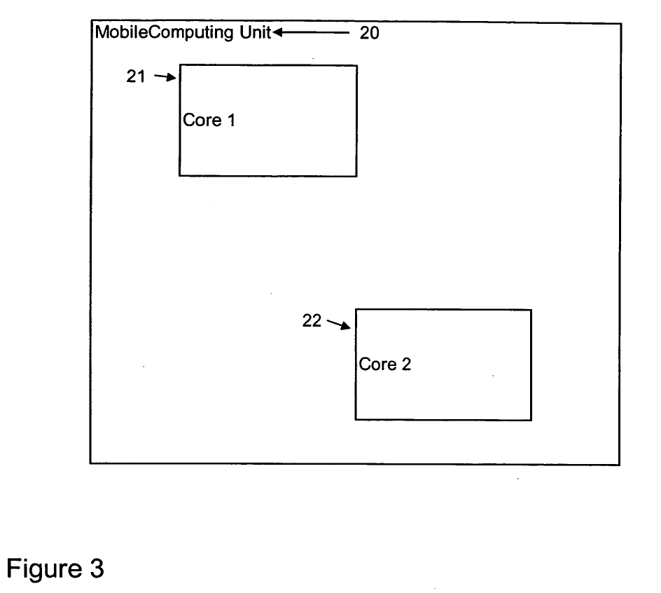

Voice recognition takes a tremendous amount of processing power. To overcome this issue in a mobile computing environment the system, can be optimized to use dual core processing or to use the new quad processors when available see FIG. 3. To take advantage of this technology the speech engine resides on one core (21) while the database and reporting functions reside on the other core (22). As quad processors become available a speech engine for auditors will reside on 3 cores while the database and reporting functions will reside on the other core. This allows the voice recognition system to operate at optimum performance. The invention is designed to take advantage of these technologies.

What is claimed is:

1. A method for populating a main database using voice recognition input based on verbal utterances of a user. The method involves: a) developing a series of data collection models, each model comprising of a series of navigational commands for populating a selected series of data fields of the main database, and each model represented by an client identifier; b) creating a predefined database for each model, the predefined database contains rules for each field. The rules may contain specific numbers, series of numbers, words or linkages to the words for each unique field: c) The invention uses Adaptive Grammar that allows the programmer to change the rules for each field. The programmer can change the rules for a field in the program and make the rule fixed or allow the rule for the particular field to be defined in the field by a supervisor. This feature allows a very high probability for accurate recognition and a rapid recognition response: d) identifying a specific field and the contents of the field, by comparing the rules of a specific field with voice recognition input. The recognition is based on a field identifying verbal utterance of a specific user; e) identifying a specific users verbal utterance from multiple user utterances and marking it with a unique identifier in the database; f) multiple users are connected using multiple concurrent audio interfaces g) recording the verified data entries within the data fields by mapping the voice recognition output generated, based on utterances of the users, to the data fields in the main database using the word mapping database for the selected fields; and repeating steps d), e), f) and g) until the users finish entering data, thereby populating the main database.

2. The method of claim 1 wherein the models, fields and word mapping databases are developed using a hierarchically organized relational database. The models, fields and word mapping databases are based upon the knowledge contained and the predefined fields in the main database; the relation organized database contains a plurality of nodes having further related nodes, fields and/or attributes.

3. The method of claim 1 wherein the voice recognition output is mapped to data items in the selected fields using a mapping database that includes or may include numbers, series of numbers, words or linkages to the words for each unique field representing spoken words or numbers for populating data items and by comparing voice recognition input to the keywords or numbers

4. The method of claim 3 where the voice recognition input is compared to the mapping database by: a) comparing the voice recognition input to the field identifiers and determining the proper field using a sequential order: b) after the proper field has been determined the voice recognition input is compared to the rules for the predefined field and determined to be acceptable or unacceptable: c) if the voice recognition was acceptable for the field the utterance is recorded in the database and then repeated to the auditor: d) the system then proceeds to the next sequential field and requests the auditors input

5. The method of claim 3 where the voice recognition input is compared to the database and determined unacceptable: a) if the system determines the noise or utterance is background noise the system ignores it and purges it from the voice engine queue: b) if the utterance is completely inappropriate the system responds “I do not understand” and returns the auditor to a starting field c) if the system accepts a wrong voice recognition output the auditor has an opportunity to make a correction

6. The method of claim 5 correcting unacceptable input: a) if the auditor determines by hearing the systems, voice engines, response that the input was incorrect the auditor says “correction” the system will respond “that the system is in correction mode and all entries will be subtracted”. If you had entered an incorrect area, product, price or quantity you would negate it from the database by negating the quantity you had entered in the incorrect entry sequence. All entries are stored to provide a true audit trail.

7. The method of claim 5 of hearing the systems voice engine response a) after each auditor's voice utterance the system attempts to recognize the utterance and if it does records the utterance in the database in the proper field. The system then echo's the recognized utterance back to the auditor. b) If the auditor isn't sure the echoed response was correct the auditor says “repeat” c) The system then repeats back the last 10 voice utterances. This is not limited to 10 utterances but is a number that was selected for feasibility.

8. A method of claim 1 populating a relational database using a hierarchical structure. This allows for systematic storage and retrieval of data. The data is stored and sorted to facilitate the production of reports requested by customers.

9. A method of claim 8 the data is stored in a main database that allows the data to be sorted: a) the data is sorted to produce reports and the reports may contain information concerning the location of the product or information, the type of product or information, the price of the product and the quantity of the product: b) the reports may accumulate locations, types or a combination of instances c) the reports may be customized to meet the clients needs

10. A method of claim 8 the data is stored in a main database and may be retrieved by auditor identification: a) the data is stored in the exact order it is received and affixed with a time stamp: b) the data can be sorted in a variety of ways to create a true audit trail that is used to validate the audit: c) the data can be sorted and printed by auditor, by location or by product

11. A method of claim 1 allowing multiple auditors, users, on the same mobile computing system: a) the system has the capability of assigning each auditor a data flow channel: b) the auditors may log in and out during the work flow: c) the auditors may individually adjust their volume on headsets to allow for noise conditions: d) the auditor may adjust the speed in which the voice recognition engine responds to their commands e) the system trains a voice recognition profile for each auditor and stores it, the voice recognition profile is continually being upgraded: f) multiple users are connected using multiple concurrent audio interfaces

12. A method of claim 1 allowing for multiple computers to be networked to: a) allow for additional auditors to work on a project: b) allow for the range of the microphones to be extended

13. A method of claim 12 allows the current limitations of computers to be overcome. Voice recognition requires a tremendous amount of computing power and the current invention developed a way to network computers to allow for additional auditors to work on a project.

14. A method of claim 12 allows the invention to overcome the current limitations regarding range of microphones: a) current microphone technology allows for a limited transmission range, 300 feet maximum: b) by networking computers the range can be extended.

15. A method of claim 12 that allows the invention to utilize mobile computers for voice recognition: a) the invention is built to allow the voice recognition system to reside on a mobile computing system: b) this allows data to be collected and generate reports in the field real time

16. A method of claim 13 allows the invention to run on dual or quad processor computers: a) by developing the invention as individual units working together it can run the voice recognition system on one core: b) by identifying each user and what channel they are recording data the invention can break specific users out to run on separate core. Thereby, allowing the invention to run at a maximum performance and with maximum users.

18. A method of claim 1 that allows the database to embed a field with a word or number: a) this allows for very specific data to be embedded in a field which increases recognition accuracy and the speed of recognition b) this allows the embedded field to be assigned to the previous entry field

19. A method of claim 18 b) allows the invention to assign a price to a particular product or item described in 18 a) when the product or item is recognized and saved in the database the price field would be skipped and the auditor be prompted to count a) this allows for increased accuracy and speed for collecting data
